(19) United States
(12) Patent Application Publication
(10) Pub. No.: US 2025/0305929 A1
(43) Pub. Date: Oct. 2, 2025

(54) PORE DEVICE

(71) Applicant: ADVANTEST CORPORATION, Tokyo (JP)

(72) Inventors: Kosuke OINUMA, Tokyo (JP); Takeaki TAKADA, Tokyo (JP); Ryohei OGAWA, Tokyo (JP); Nobuei WASHIZU, Tokyo (JP)

(21) Appl. No.: 19/098,044

(22) Filed: Apr. 2, 2025

(30) Foreign Application Priority Data
Apr. 2, 2024 (JP) 2024-059649

(51) Int. Cl. G01N 15/13; G01N 15/12

(52) U.S. Cl. CPC G01N 15/13; G01N 2015/135

(57) ABSTRACT

A pore device has a device main body and a sealing member. The device main body has a first chamber and a second chamber that communicate through a pore, and at least one injection port through which an electrolyte solution is injected into the first chamber and the second chamber. The device main body has inside thereof a hydrophilic group provided thereto. The sealing member is structured to seal the injection port, while the first chamber and the second chamber are filled with the electrolyte solution.

### REFERENCE TO RELATED APPLICATIONS

The present invention claims priority under 35 U.S.C. § 119 to Japanese Patent Application No. 2024-059649 filed on Apr. 2, 2024, the entire contents of which are incorporated herein by reference.

### BACKGROUND

### 1. Technical Field

The present disclosure relates to a pore device.

### 2. Description of the Related Art

Method for measuring particle size distribution called electrical sensing zone method (based on the Coulter's principle) has been known. In this measurement method, an electrolyte solution that contains a particle is allowed to pass through a pore called nanopore. During passage of the particle through the pore, the electrolyte solution in the pore will decrease the volume by an amount equivalent to the volume of the particle, thus increasing electric resistance of the pore. The volume (or, particle size) of the particle can therefore be determined, by measuring the electric resistance of the pore.

FIG. 1 is a block diagram illustrating a microparticle measurement system 1R making use of the electrical sensing zone method. A microparticle measurement system 1R has a pore device 100R, a measuring instrument 200R, and a data processor 300.

The inside of the pore device 100R is filled with an electrolyte solution 2 that contains particles 4 to be detected. The inside of the pore device 100R is partitioned by a pore chip 102 into two spaces, in which an electrode 106 and an electrode 108 are individually provided. Under potential difference generated between the electrode 106 and the electrode 108, an ion current flows between the electrodes, during which the particles 4 migrate from one space through the pore 104 into the other space while driven by electrophoresis.

The measuring instrument 200R generates the potential difference between the pair of the electrodes 106, 108, and acquires information correlated with resistivity Rp between the electrode pair. The measuring instrument 200R has a transimpedance amplifier 210, a voltage source 220, and a digitizer 230. The voltage source 220 is structured to generate a potential difference Vb between the pair of electrodes 106, 108. The potential difference Vb provides a driving force of electrophoresis, as well as a bias signal for measuring the resistivity Rp.

Between the pair of electrodes 106, 108, there flows microcurrent Is which is inversely proportional to the resistivity of the pore 104.

$$Is = V b / Rp \qquad ( 1 )$$

The transimpedance amplifier 210 is structured to convert the microcurrent Is into a voltage signal Vs. Given a conversion gain as r, an equation below holds.

$$V s = - r \times Is \qquad ( 2 )$$

Substitution of equation (1) into the equation (2) gives equation (3) below.

$$V s = - V b \times r / Rp \qquad ( 3 )$$

The digitizer 230 is structured to convert the voltage signal Vs into digital data Ds. In this way, the voltage signal Vs inversely proportional to the resistivity Rp of the pore 104 is obtainable, with use of the measuring instrument 200R.

FIG. 2 is an exemplary waveform chart of the microcurrent Is measured by the measuring instrument 200R. Note that the ordinates and abscissae of the waveform charts or time charts referred to herein are appropriately enlarged or shrunk for easy understanding, and also the waveforms illustrated herein are simplified, exaggerated or emphasized for easy understanding.

During a short period of passage of each particle, the resistivity Rp of the pore 104 increases. The current Is therefore decreases in a pulsated manner, every time one particle passes. Amplitude of each pulse current correlates with the particle size. The data processor 300 is structured to process the digital data Ds, and to typically analyze the count or particle size of the particles 4 contained in the electrolyte solution 2. A part of the data processor 300 may be placed in a server or a cloud.

Preparation for the pore device 100R before use will be described. The pore device 100R is necessarily subjected to hydrophilic treatment before use. If the electrolyte solution is injected into the pore device 100R not having been subjected to the hydrophilic treatment, air bubbles would adhere typically to an inner wall face of the internal space, faces of the electrodes (interconnects) 106, 108, a face of the pore chip 102, or the pore 104.

Air bubbles will raise several issues. For example, the air bubbles if adhered to the pore 104 will destabilize through-current of the pore 104, and will also obstruct a path of the particles 4 that pass through the pore 104, thus making it difficult to conduct normal particle measurement.

The air bubbles, if adhered to the middle of the internal space that serves as a flow path, will narrow the flow path, thus inhibiting the particles from dispersing uniformly.

The air bubbles, if adhered to the electrodes 106, 108, will cause contact failure with the electrolyte solution 2, thus inhibiting thorough ion exchange, and making it unable to acquire normal measurement current.

To address these issues, the prevailing view is that hydrophilic treatment inside the pore device 100R is preferred, prior to injection of the electrolyte solution. Among various methods of hydrophilic treatment, an exemplary known technique is to provide a hydrophilic group to the inside of the pore device 100R, typically by aqua plasma irradiation.

It is not easy for the user of the pore device 100R to subject it to the hydrophilic treatment. Moreover, an effect of the hydrophilic treatment lasts only approximately several days to one week, since the hydrophilic group decreases upon exposure to the atmosphere. At present, it is therefore necessary for the manufacturer of the pore device 100R to subject the device to the hydrophilic treatment and to deliver the device to the user, while adjusting timing to the user's schedule of use of the pore device 100R. Also the user who received the pore device 100R needs to use the pore device 100R within several days.

JP 7282177 B discloses a technique of accommodating a plurality of pore devices after the hydrophilic treatment, in a container filled with an electrolyte solution. This technique can achieve a long shelf life, since the hydrophilic group is not exposed to the atmosphere, and can therefore be suppressed from decreasing.

The method described in JP 7282177 B, however, suffers from a risk that the pore device accommodated in the container would have dirt getting therein to cause clogging of the pore, if the container per se has the dirt adhered thereto. Also an impurity contained in the container would cause a chemically adverse effect.

Another disadvantage is that the container, stored with the solution filled therein, will be heavy, and will thus degrade portability.

The pore device, when taken out for use from the container, needs to be wiped in order to remove the electrolyte solution adhered on the exterior of the pore device. This is labor-consuming for the user. Also wiping off of the electrolyte solution would pose another risk of adhesion of an impurity.

Furthermore, an additional need for waste disposal of the electrolyte solution in the container poses a bothering issue for the user.

In a mode where a plurality of devices is stored in a single container, opening once of the container, and take-out of one or more devices will cause contamination which can adversely affect other device. Such mode is therefore not so desirable for a microparticle detection device.

Moreover, contact parts between probes of the measuring instrument 200R and the electrodes 106, 108 are inevitably immersed in the electrolyte solution. This raises a need for an anticorrosive measure for the contact parts.

### SUMMARY

The present disclosure has been arrived at considering such circumstances, and one exemplary embodiment thereof is to provide a pore device having a long shelf life without degrading the reliability.

A pore device according to one embodiment of the present disclosure includes a device main body having a first chamber and a second chamber that communicate through a pore, and at least one injection port through which an electrolyte solution is injected into the first chamber and the second chamber, wherein hydrophilic groups are provided on an internal surface of the main body; and a sealing member structured to seal the at least one injection port, while the first chamber and the second chamber are filled with the electrolyte solution.

Another aspect of the present disclosure relates to a method for manufacturing the pore device. The method for manufacturing includes: providing hydrophilic groups to an internal surface of a device main body having a first chamber and a second chamber that communicate through a pore, and at least one injection port through which an electrolyte solution is injected into the first chamber and the second chamber; injecting an electrolyte solution through the at least one injection port into the device main body; and sealing the at least one injection port with a sealing member.

It is to be noted that any arbitrary combination or rearrangement of the above-described structural components and so forth is effective as and encompassed by the present embodiments. Moreover, all of the features described in this summary are not necessarily required by embodiments so that the embodiment may also be a sub-combination of these described features. In addition, embodiments may have other features not described above.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a block diagram illustrating a microparticle measurement system making use of the electrical sensing zone method;

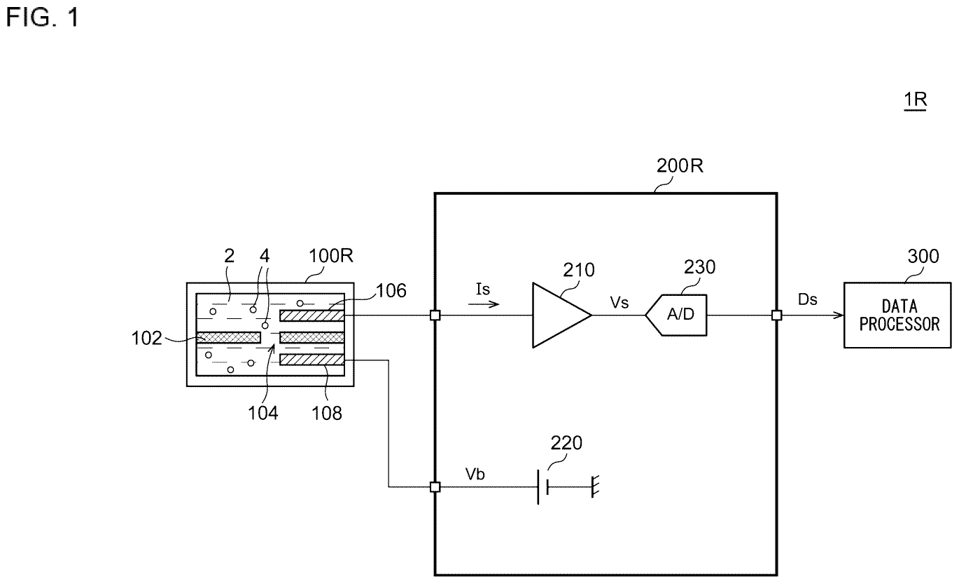

FIG. 2 is an exemplary waveform chart of microcurrent Is measured with a measuring instrument;

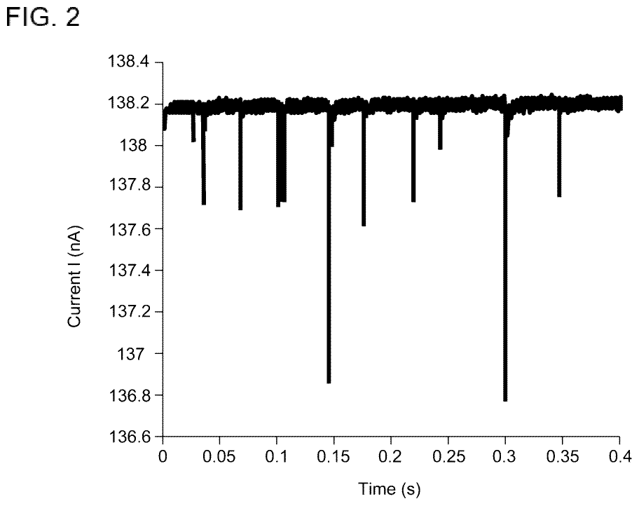

FIG. 3 is a cross-sectional view of a pore device according to one embodiment;

FIG. 4 is a diagram for explaining a method for manufacturing the pore device according to one embodiment;

FIG. 5 is a cross-sectional view of a device main body according to Example 1;

FIG. 6 is a drawing illustrating a result of a surface component analysis of an electrode part of a comparative sample manufactured without forming a carbon barrier layer;

FIG. 7 is a drawing illustrating a result of a surface component analysis of an electrode part of a sample having a carbon barrier layer;

FIG. 8 is a cross-sectional view of a device main body according to Example 2;

FIG. 9 is a cross-sectional view of a device main body according to Modified Example 1; and

FIG. 10 is a cross-sectional view of a device main body according to Modified Example 2.

### DETAILED DESCRIPTION

### Outline of Embodiments

An outline of several example embodiments of the disclosure follows. This outline is provided for the convenience of the reader to provide a basic understanding of such embodiments and does not wholly define the breadth of the disclosure. This outline is not an extensive overview of all contemplated embodiments and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “one embodiment” may be used herein to refer to a single embodiment or multiple embodiments of the disclosure.

A pore device according to one embodiment includes a device main body having a first chamber and a second chamber that communicate through a pore, and at least one injection port through which an electrolyte solution is injected into the first chamber and the second chamber, wherein hydrophilic groups are provided on an internal surface of the device main body; and a sealing member structured to seal the at least one injection port, while the first chamber and the second chamber are filled with the electrolyte solution.

The pore device is shipped as a product, with the inside of the device main body filled with the electrolyte solution, and with the at least one injection port sealed. After peeling off the sealing member, the user can inject a liquid that contains a particle to be detected through the at least one injection port. This structure, keeping the hydrophilic group away from contact with the air, has a long shelf life. Moreover, there is no need to soak the device main body in a preservative solution, and this makes it no longer necessary to wipe the device main body and can prevent contamination with the preservative solution.

In one embodiment, the device main body may include a pore chip having a pore formed therein, and a pore chip case that accommodates the pore chip, whose inside is partitioned into the first chamber and the second chamber by the pore chip. The pore chip case may include a body that accommodates the pore chip and having the first chamber and the second chamber, and a substrate connected to the body, and having electrodes formed thereon, which are at least partially exposed to an internal space of the body.

In one embodiment, each of the electrodes may include a first metal layer formed on the substrate; and a carbon barrier layer formed in a layer above the first metal layer, in a part exposed to the internal space of the body. This structure can block chloride ions contained in the electrolyte solution with use of the carbon barrier layer and can therefore prevent the chloride ions from reaching the first metal layer, thus improving the reliability.

In one embodiment, the substrate may be a printed circuit board, the material of the first metal layer may be Cu, and the electrodes may further include a second metal layer of Ni formed on the first metal layer, and a third metal layer of Au formed on the second metal layer. The carbon barrier layer may be formed on the third metal layer. This successfully prevent Cu from degrading.

In one embodiment, the substrate is a film substrate, and a material of the first metal layer may be Ag (silver). This successfully prevent Ag from being chlorinated.

In one embodiment, the carbon barrier layer may also be formed in a part exposed to an outer space of the body. This successfully prevents Ag from being oxidized.

In one embodiment, the carbon barrier layer may have a thickness of 10 μm to 30 μm.

In one embodiment, each electrode may further have an Ag/AgCl (silver/silver chloride) layer formed on the carbon barrier layer. This successfully allows the ion exchange with the electrolyte solution to proceed efficiently.

A microparticle measurement system according to one embodiment may have the aforementioned pore device; and a measuring instrument structured to apply an electrical signal to the electrodes of the pore device, and to measure an electrical signal generated in the pore device.

A method for manufacturing according to one embodiment includes: providing hydrophilic groups to an internal surface of a device main body having a first chamber and a second chamber that communicate through a pore, and at least one injection port through which an electrolyte solution is injected into the first chamber and the second chamber; injecting an electrolyte solution through the injection port(s) into the device main body; and sealing the at least one injection port with a sealing member.

In one embodiment, the manufacturing method may further include testing the device main body after injecting the electrolyte solution. The sealing step may come after the testing.

### Embodiments

Preferred embodiments will be explained below, referring to the attached drawings. All similar or equivalent constituents, members and processes illustrated in the individual drawings will be given same reference numerals, so as to properly avoid redundant explanations. The embodiments are merely illustrative and are not restrictive about the invention. All features and combinations thereof described in the embodiments are not always necessarily essential to the disclosure and invention.

Dimensions (thickness, length, width, etc.) of the individual members illustrated in the drawings may be appropriately enlarged or shrunk for easy understanding. Furthermore, the dimensions of the plurality of members do not necessarily indicate the dimensional relationship among them, so that a certain member A, if depicted thicker than another member B in a drawing, may even be thinner than the member B.

In the present specification, a “state in which a member A is coupled to a member B” includes a case where the member A and the member B are physically and directly coupled, and a case where the member A and the member B are indirectly coupled while placing in between some other member that does not substantially affect the electrically coupled state, or does not degrade the function or effect demonstrated by the coupling thereof.

Similarly, a “state in which a member C is provided between the member A and the member B” includes a case where the member A and the member C, or the member B and the member C are directly coupled, and a case where they are indirectly coupled, while placing in between some other member that does not substantially affect the electrically coupled state among the members, or does not degrade the function or effect demonstrated by the members.

In the present specification, reference signs attached to electric signals such as voltage signal and current signal, or circuit elements such as resistor, capacitor, and inductor represent voltage value, current value, or circuit constants (resistivity, capacitance, and inductance) of the individual components as necessary.

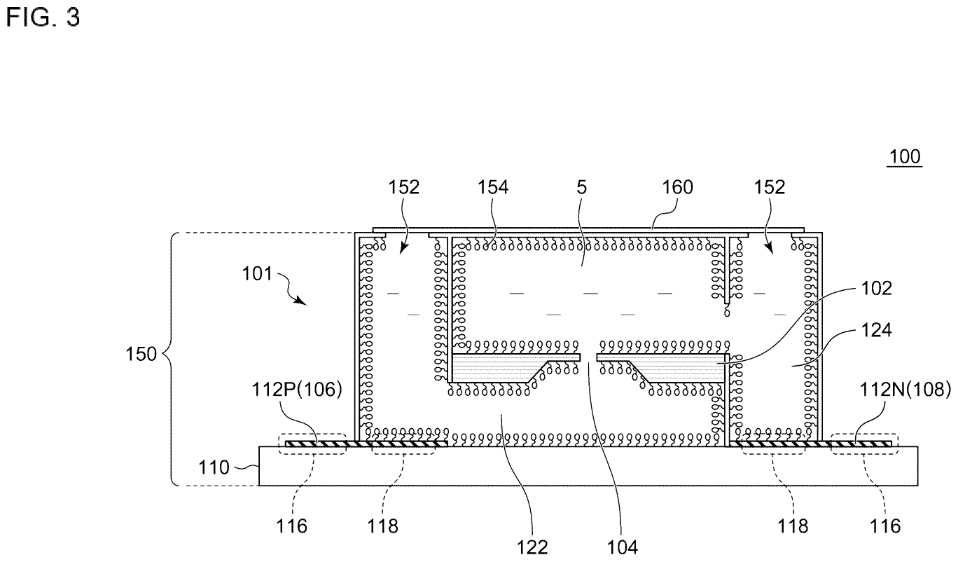

FIG. 3 is a cross-sectional view of a pore device 100 according to one embodiment. The pore device 100 has a device main body 150 and a sealing member 160. The device main body 150 includes a first chamber 122 and a second chamber 124 that communicate through the pore 104. The device main body 150 has injection ports 152 through which an electrolyte solution that contains a particle to be measured is injected into the first chamber 122 and the second chamber 124, at the time of measurement. The device main body 150 is also provided with the electrodes 106, 108 for applying an electric field between the first chamber 122 and the second chamber 124.

The device main body 150 has, inside thereof, a hydrophilic group 154 provided typically by plasma treatment.

The insides of the first chamber 122 and the second chamber 124 of the device main body 150 are filled with a preservative electrolyte solution 5, so as to keep the hydrophilic group 154 away from contact with the air.

The sealing member 160 is structured to seal the injection ports 152, while the first chamber 122 and the second chamber 124 are filled with the preservative electrolyte solution 5.

When using the pore device 100, the sealing member 160 is peeled off from the device main body 150 to expose the injection ports 152. The sealing member 160, although illustrated in FIG. 3 as a single component that closes two injection ports 152, is not limited thereto in the present disclosure, instead allowing that a separate sealing member 160 is provided to each injection port 152. If the device main body 150 has any opening other than the injection ports 152, like an air vent hole for example, the sealing member 160 is placed so as to close such other opening.

The overall structure of the pore device 100 has been described. The pore device 100 is shipped as a product, with the inside of the device main body 150 filled with the preservative electrolyte solution 5, and with the injection ports 152 sealed. The user can inject the solution that contains particles to be measured through the injection ports 152, after peeling off the sealing member 160. This structure ensures a long shelf life, since the hydrophilic group 154 is kept away from contact with the air.

Moreover, there is no need to soak the device main body 150 per se in a preservative solution, thereby making it no longer necessary to wipe the device main body 150.

In addition, since the contact parts between probes of the measuring instrument 200R and the electrodes 106, 108 are not immersed in the electrolyte solution, it is no longer necessary to take measures to prevent corrosion of the contact parts.

Note now, the technique of storing a plurality of pore devices in the same container as in the prior art has been anticipated to pollute the preservative solution when taking out a pore device, which would eventually pollute the other pore device. In contrast, this embodiment will not cause such problem.

The preservative electrolyte solution 5 will be a waste solution after the measurement. The volume thereof will, however, be much less than the volume of the preservative solution described in JP 7282177 B.

Another advantage is that the device is easy to handle since being individually packaged.

The structure of the device main body 150 is not particularly limited. The technology of the present disclosure is applicable to various pore devices having been known or will be available in the future. Hereinafter, an exemplary structure of the device main body 150 will be described.

The device main body 150 has the pore chip 102, and a pore chip case 101 that houses the pore chip 102. The pore chip 102 has a pore 104 formed therein. The pore chip case 101 has two spaces 122, 124 partitioned by the pore chip 102. When shipped or stored, the spaces 122, 124 are filled with the preservative electrolyte solution 5. During the measurement, the spaces are filled with the electrolyte solution that contains the particles 4.

The pore chip case 101 typically includes a substrate 110 and a body 120. The body 120 is provided on the substrate 110. The substrate 110 has, formed thereon, interconnects 112P, 112N that correspond to the electrodes 106, 108, respectively. Each of the interconnects 112P, 112N is drawn out from the inside of the spaces 122, 124 of the body 120, allowed for an ion exchange reaction with the electrolyte solution 2 in an ion exchange region 118 inside the body 120, and is electrically connectable to the measuring instrument 200 in an external contact region 116.

An exemplary structure of the device main body 150 has been described.

Next, a method for manufacturing the pore device 100 will be described.

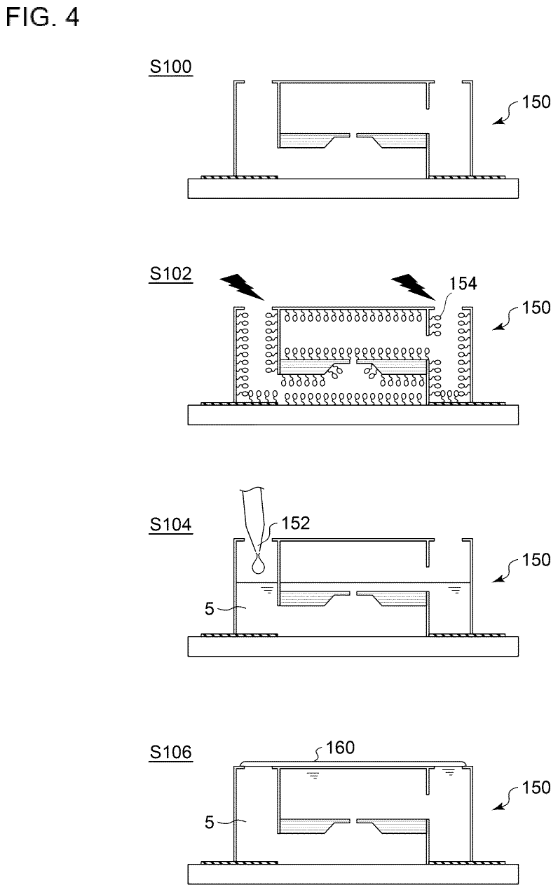

FIG. 4 is a diagram for explaining a method for manufacturing the pore device 100 according to one embodiment. First, the device main body 150 is manufactured (S100). Although the method for manufacturing the device main body 150 differs depending on the structure or system of the device main body 150, the present disclosure does not particularly limit the structure or system of the device main body 150, so that the method will not be described herein.

The inside of the device main body 150 is subjected to the hydrophilic treatment (S102). Among various known methods of hydrophilic treatment, aqua plasma irradiation for example is applicable to provide the hydrophilic group 154 to the inside of the device main body 150.

Next, the preservative electrolyte solution 5 is injected through the injection port 152 into the device main body 150 (S104). The inside of the device main body 150 is thus filled with the preservative electrolyte solution 5 while purging the air from inside the device main body 150, whereby the hydrophilic group 154 will no longer contact with the air.

The sealing member 160 is then placed so as to close the injection ports 152 of the device main body 150 (S106).

The method for manufacturing the pore device 100 has been described.

Next, inspection of the pore device 100 will be described. Shape and size of the pore of the pore chip largely affect the measurement accuracy. Note that mechanical workmanship evaluation of the pore, however, typically needs a scanning electron microscope (SEM). In particular, exact evaluation of a pore of several nanometers to several hundred nanometers typically requires a critical-dimension scanning electron microscope (CD-SEM), with which 100% inspection is not practical. On the other hand, an electrical test has required immersion of the inside of the pore device 100 with the electrolyte solution. Also the electrical test was therefore not applicable to 100% inspection of the pore devices having been subjected to the hydrophilic treatment and shipped in a dry state. It has, therefore, been a common practice to provide quality assurance lot by lot, by sampling inspection.

In contrast, the aforementioned pore device 100 has an advantage of enabling 100% inspection. In the manufacturing process of the pore device 100, an electrical test is feasible for the device main body 150 having been subjected to the hydrophilic treatment, and having the electrolyte solution injected therein. It is, therefore, possible to subject all the products to the electrical test, after injecting therein the electrolyte solution, and to ship only the products that have passed the test, with the sealing member 160 provided thereto. The 100% inspection can further improve quality and reliability of the pore device 100.

Next, an anticorrosive measure for the electrodes 106, 108 will be described.

Since the device main body 150 is not immersed in the preservative solution as described above, so that the contact regions 116 of the interconnects 112P, 112N, which correspond to the electrodes 106, 108, respectively, are free from risk of corrosion, and therefore have no need of special treatment.

On the other hand, in order to maintain the performance of the pore device 100 for as long as several months to years, the ion exchange regions 118 of the interconnects 112P, 112N need an anticorrosive measure.

Corrosion of the interconnects 112P, 112N will be described.

For the substrate 110, candidates listed herein include film substrate of polyethylene terephthalate (PET) or the like, printed circuit board, and glass substrate.

The PET substrate is often used for the single-use (disposable) pore device 100R, for its inexpensiveness and high workability. On the PET substrate, which is however less heat-resistant, the interconnects 112P, 112N are often formed with use of silver particles allowed for low temperature forming.

Silver is, however, rapidly oxidized, and will have an insulating silver oxide film formed on the surface thereof. The insulating film prevents electrical connection with the substrate 110, in the contact region 116. Electrical connection with the silver interconnect, if tried typically with use of a pogo pin, may be established after breaking the insulating silver oxide film by wiping to create a newly exposed surface. The contact, however, tends to be destabilized due to thinness of the silver interconnects.

The printed circuit board is usually used in electrode formation, which is formed of a glass-epoxy material typically in a class of flame retardant type 4 (FR-4). On the printed circuit board, the interconnect layer is formed of copper and is typically plated with gold, so that the interconnects will be free from risk of oxidation unlike on the PET substrate and can keep good contact with the external electrodes.

However, considering the use as the substrate 110 of the pore device 100, which may be stored for a long period while filling up the inside of the body 120 with the preservative electrolyte solution 5, chloride ions contained in the preservative electrolyte solution 5 would permeate through the silver/silver chloride electrodes and through the underlying gold plating, to reach the interconnects made of copper. This would chlorinate the copper, thus allowing insulating copper chloride to deposit on the surface of the electrodes, whereby contact failure would occur.

The glass substrate is often used in electrochemical measurement with use of an electrolyte solution. Glass, whose melting point is high, is allowed for direct formation of gold interconnect by vapor deposition. Glass has therefore a low risk of chlorination concerned on the printed circuit board, or contact failure concerned on the PET substrate. Glass however costs one digit or more higher and is not suitable for the disposable pore device.

Hereinafter, a preferred interconnect structure in the device main body 150 will be described.

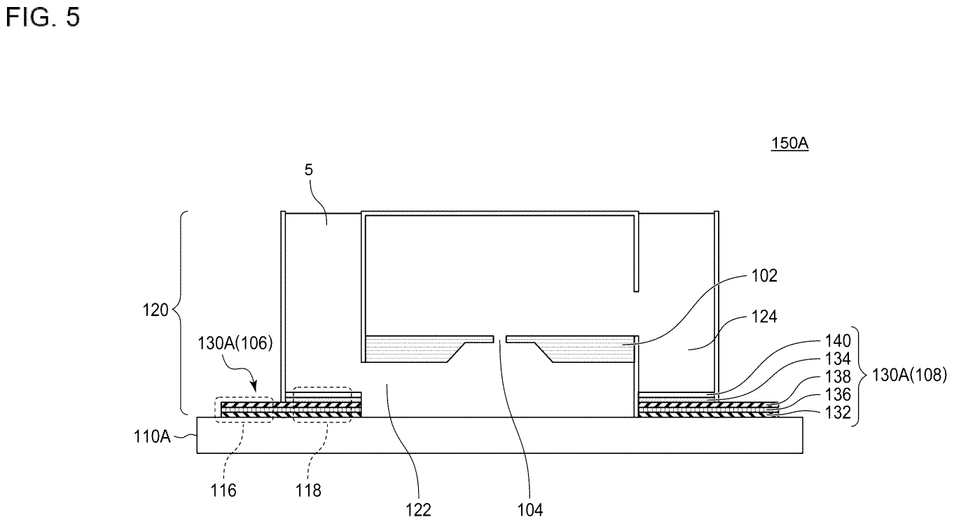

FIG. 5 is a cross-sectional view of a device main body 150A according to Example 1. The description below will be focused on the interconnect structure.

The first electrode 106 and the second electrode 108 are interconnects 130A having the same interconnect structure.

Each interconnect 130A includes a first interconnect layer 132, a second interconnect layer 136, a third interconnect layer 138, a carbon barrier layer 134, and an Ag/AgCl layer 140, which are stacked in this order on a printed circuit board 110A. The first interconnect layer 132 is formed of Cu, the second interconnect layer 136 is formed of Ni, and the third interconnect layer 138 is formed of Au. The carbon barrier layer 134 is electro-conductive and is formed on the third interconnect layer 138. On the carbon barrier layer 134, and specifically on a part thereof (ion exchange region) exposed inside the body 120, there is formed the Ag/AgCl layer 140 intended for efficient ion exchange with the electrolyte solution 2.

The carbon barrier layer 134 preferably has a thickness of approximately 10 μm to 30 μm, which is specifically and preferably 20 μm or around. Within this range, chloride ions is successfully blocked, while suppressing the manufacturing cost from increasing.

An exemplary structure of the device main body 150A has been described. Next, the advantage will be explained. In order to verify the advantage of the carbon barrier layer 134 in the device main body 150A, a sample device having the carbon barrier layer, and a comparative sample device without the carbon barrier layer were manufactured. The two samples were then filled inside with the electrolyte solution and energized and then subjected to a surface component analysis of the electrodes.

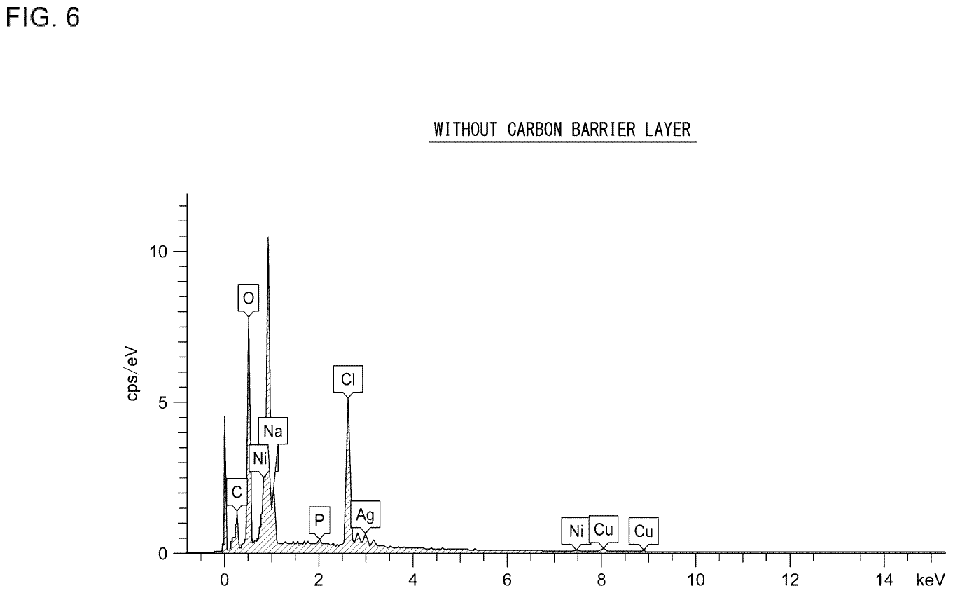

FIG. 6 is a drawing illustrating a result of a surface component analysis of an electrode part of a comparative sample manufactured without forming a carbon barrier layer. The sample manufactured without forming the carbon barrier layer was found to have much Cu and Cl detected on the surface of the electrodes.

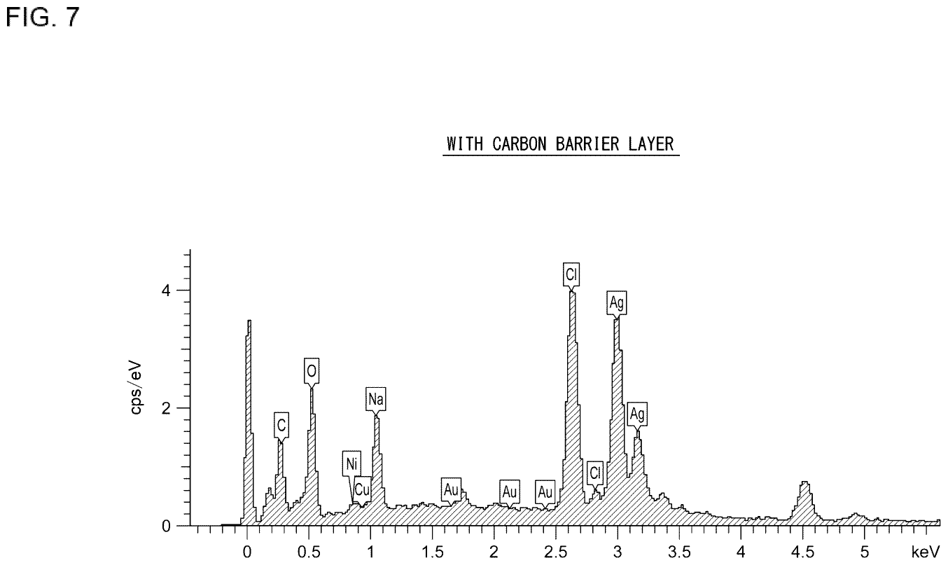

FIG. 7 is a drawing illustrating a result of the surface component analysis of the electrode part of the sample having the carbon barrier layer. The sample having the carbon barrier layer was found to have no Cu appeared on the surface, instead having much Ag contained in the Ag/AgCl layer 140 detected on the surface.

The device main body 150A illustrated in FIG. 5 can prevent chloride ions, having been contained in the preservative electrolyte solution 5, from reaching the first interconnect layer 132. This makes it possible to prevent generation of copper chloride in the first interconnect layer 132, and deposition of copper chloride on the surface of the electrodes.

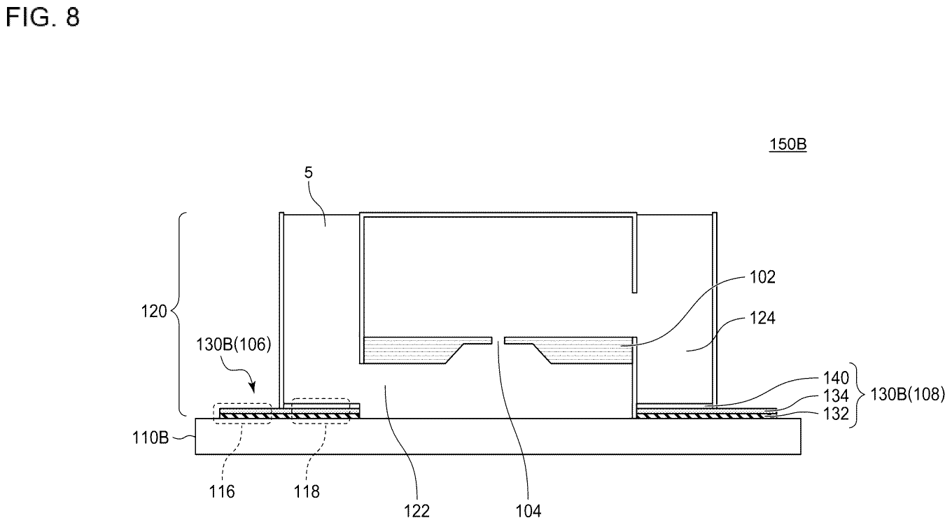

FIG. 8 is a cross-sectional view of a device main body 150B according to Example 2. The device main body 150B according to Example 2 has a film substrate 110B, in place of the printed circuit board 110A. The film substrate 110B is typically formed of a PET substrate, on which the electrodes 106, 108 are formed. The electrodes 106, 108 are formed of interconnects 130B having the same structure. Material of the film substrate 110B is not limited to PET, instead allowing use of polyimide, cycloolefin polymer, acrylic resin or the like, for the manufacture.

Each interconnect 130B has the first interconnect layer 132, the carbon barrier layer 134, and the Ag/AgCl layer 140 which are stacked. The first interconnect layer 132 is formed of Ag. The carbon barrier layer 134 is formed on the first interconnect layer 132. The carbon barrier layer 134 is formed both inside and outside of the body 120.

An exemplary structure of the device main body 150B has been described. Inside the body 120 of the device main body 150B, the carbon barrier layer 134 can prevent the chloride ions in the preservative electrolyte solution 5 from reaching the first interconnect layer 132.

Outside the body 120, the carbon barrier layer 134 can prevent the first interconnect layer 132 from being oxidized.

Next, modified examples of the interconnect 130 will be described.

### Modified Example 1

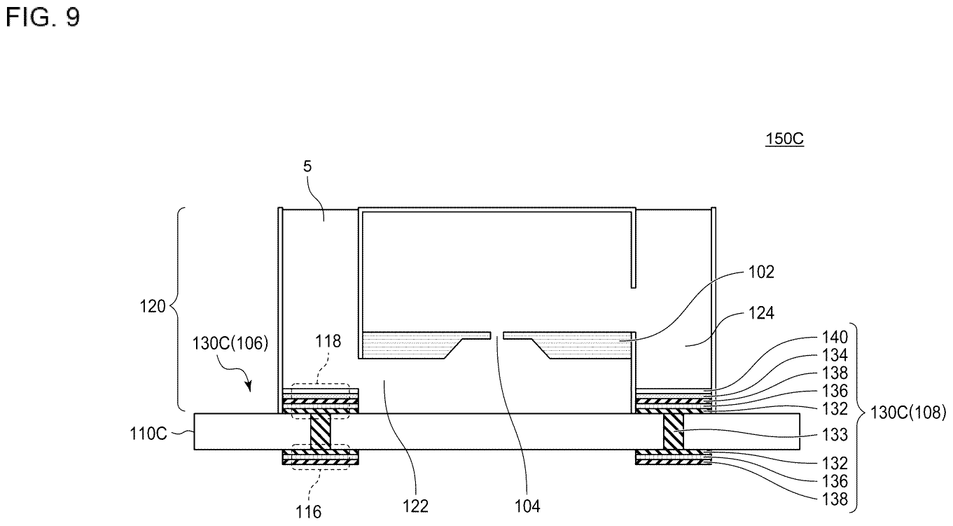

FIG. 9 is a cross-sectional view of a device main body 150C according to Modified Example 1. The contact region, having been formed on the top face of the substrate 110 in Examples 1 and 2, is not necessarily limited thereto. The contact region 116 in Modified Example 1 is formed on the back face of the substrate 110C, that is, on the opposite side of the ion exchange region 118.

An interconnect 130C has an interconnect or a pad that contains the first interconnect layer 132, the carbon barrier layer 134, and the third interconnect layer 138 stacked on the back face of the substrate 110C. The first interconnect layer 132 on the top face of the substrate 110C and the first interconnect layer 132 on the back face are connected by a viahole 133.

### Modified Example 2

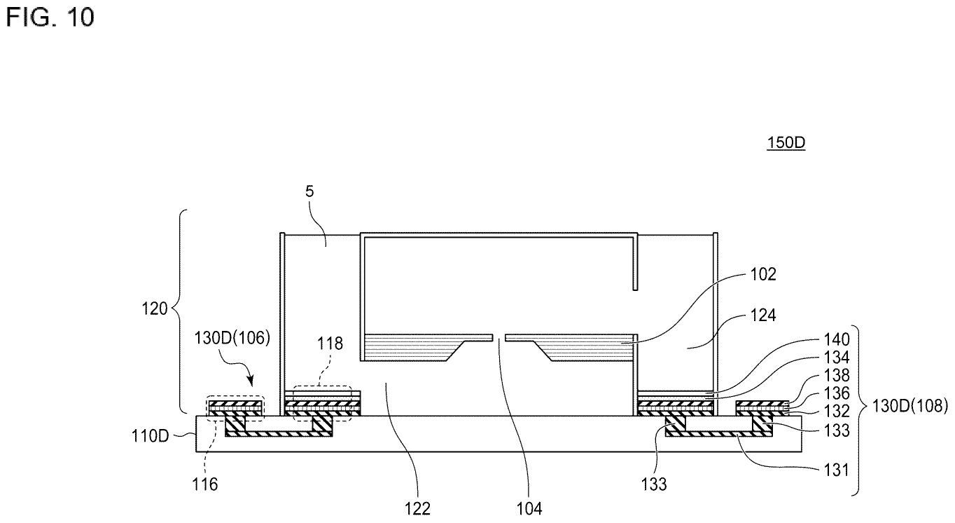

FIG. 10 is a cross-sectional view of a device main body 150D according to Modified Example 2. In Modified Example 2, the contact region 116 and the ion exchange region 118 are connected through an interconnect 131 and viaholes 133 both buried in a printed circuit board 110D.

Having described the present disclosure with use of specific terms referring to the embodiments, the embodiments merely illustrate the principle and applications of the present disclosure, allowing a variety of modifications and layout change without departing from the spirit of the present disclosure specified by the claims.

What is claimed is:

1. A pore device comprising:
a device main body having a first chamber and a second chamber that communicate through a pore, and at least one injection port through which an electrolyte solution is injected into the first chamber and the second chamber, wherein hydrophilic group are provided on an internal surface of the main body; and
a sealing member structured to seal the at least one injection port, while the first chamber and the second chamber are filled with the electrolyte solution.

2. The pore device according to claim 1, wherein the device main body includes:
a pore chip having the pore formed therein; and
a pore chip case structured to accommodate the pore chip, whose inside is partitioned into the first chamber and the second chamber by the pore chip, wherein
the pore chip case includes:
a body structured to accommodate the pore chip, and has the first chamber and the second chamber; and
a substrate connected to the body, and having electrodes formed thereon, which are at least partially exposed to an internal space of the body.

3. The pore device according to claim 2, wherein each of the electrodes includes:
a first metal layer formed on the substrate; and
a carbon barrier layer formed in a layer above the first metal layer, in a part exposed to the internal space of the body.

4. The pore device according to claim 3, wherein
the substrate is a printed circuit board,
a material of the first metal layer is Cu,
the electrode further comprises:
a second metal layer of Ni formed on the first metal layer; and
a third metal layer of Au formed on the second metal layer, and
the carbon barrier layer is formed on the third metal layer.

5. The pore device according to claim 3, wherein
the substrate is a film substrate, and the material of the first metal layer is Ag.

6. The pore device according to claim 3, wherein
the carbon barrier layer is also formed in a part exposed to an external space of the body.

7. The pore device according to claim 3, wherein the carbon barrier layer has a thickness of 10 μm to 30 μm.

8. The pore device according to claim 3, wherein
each of the electrodes further comprises an Ag/AgCl layer formed on the carbon barrier layer.

9. A microparticle measurement system comprising:
the pore device according to claim 1; and
a measuring instrument structured to apply an electrical signal to electrodes of the pore device, and to measure an electrical signal generated in the pore device.

10. A method for manufacturing a pore device, the method comprising:
providing hydrophilic groups to an internal surface of a device main body having a first chamber and a second chamber that communicate through a pore, and at least one injection port through which an electrolyte solution is injected into the first chamber and the second chamber;
injecting an electrolyte solution through the at least one injection port into the device main body; and
sealing the at least one injection port with a sealing member.

11. The method for manufacturing a pore device according to claim 10, the method further comprising testing the device main body after injecting the electrolyte solution, wherein
the sealing comes after the testing.
